(19) United States
(12) Patent Application Publication
(10) Pub. No.: US 2011/0292139 A1
(43) Pub. Date: Dec. 1, 2011

(54) LIQUID CARTRIDGE FOR IMAGE FORMING DEVICE

(75) Inventors: Noritsugu ITO, Tokoname-shi (JP); Mikio HIRANO, Obu-shi (JP); Hisashi IGI, Nagoya-shi (JP)

(73) Assignee: Brother Kogyo Kabushiki Kaisha, Nagoya-shi (JP)

(21) Appl. No.: 13/096,739

(22) Filed: Apr. 28, 2011

(30) Foreign Application Priority Data
Apr. 30, 2010 (JP) 2010-105937

(51) Int. Cl. B41J 2/175; B41J 29/38

(52) U.S. Cl. 347/86; 347/5

(57) ABSTRACT

A liquid cartridge detachably mountable on a body of an image forming device and capable of supplying liquid to the image forming device when mounted on the body. A liquid delivery path has a first portion and a second portion positioned between a liquid accommodating unit and the first portion. A first opening/closing unit is configured so as to be capable of being switched between an open state in which the first portion is opened and a closed state in which the first portion is closed. A second opening/closing unit is configured so as to be capable of being switched between an open state in which the second portion is opened and a closed state in which the second portion is closed. A storing unit is configured to store time length data indicating a length of a prescribed time. A second opening/closing unit is changed from the closed state to the open state when the prescribed time has elapsed after the liquid cartridge is mounted on the body.

### CROSS REFERENCE TO RELATED APPLICATION

This application claims priority from Japanese Patent Application No. 2010-105937 filed Apr. 30, 2010. The entire content of the priority application is incorporated herein by reference.

### TECHNICAL FIELD

The present invention relates to a liquid cartridge and an image forming device for forming images using liquid supplied from the liquid cartridge.

### BACKGROUND

Image forming devices that form images using liquid supplied from liquid cartridges are well known in the art. An example of this type of image forming device is an inkjet recording device employing ink cartridges as the liquid cartridges. The ink cartridge houses an ink bag. A valve is provided on the ink bag for supplying ink externally from the ink bag. The valve includes a spring, a spring seat, and a sealing lid. An ink supplying needle (ink delivery tube) provided in the inkjet recording device penetrates the sealing lid and moves the spring seat, allowing ink in the ink bag to pass through the ink supplying needle and be supplied to the inkjet recording device.

### SUMMARY

However, when a user mounts an ink cartridge in the body of the conventional recording device described above, the mounting motion of the ink cartridge produces a change in ink pressure inside the ink cartridge. This change in ink pressure produced when an ink cartridge is mounted in the body of the recording device may be transmitted to the recording head, breaking the meniscuses formed in the nozzles of the recording head and, hence, allowing ink to leak from the nozzles. If printing is performed while ink is leaking in this state, ink ejection problems may occur in the recording head due to the broken meniscuses.

In view of the foregoing, it is an object of the present invention to provide a liquid cartridge capable of preventing the conventional ink ejection problems from occurring in the recording head. It is another object of the present invention to provide an image forming device that forms images using liquid supplied from such liquid cartridges.

In order to attain the above and other objects, the present invention provides a liquid cartridge detachably mountable on a body of an image forming device and capable of supplying liquid to the image forming device when mounted on the body. The liquid cartridge includes a liquid accommodating unit, a liquid delivery path, a first opening/closing unit, a second opening/closing unit, and a storing unit. The liquid accommodating unit is configured to accommodate liquid therein. The liquid delivery path is in fluid communication with the liquid accommodating unit and supplies liquid externally from the liquid accommodating unit. The liquid delivery path has a first portion and a second portion positioned between the liquid accommodating unit and the first portion. The first opening/closing unit is configured so as to be capable of being switched between an open state in which the first portion is opened and a closed state in which the first portion is closed. The second opening/closing unit is configured so as to be capable of being switched between an open state in which the second portion is opened and a closed state in which the second portion is closed. The storing unit is configured to store time length data indicating a length of a prescribed time. The second opening/closing unit is changed from the closed state to the open state when the prescribed time has elapsed after the liquid cartridge is mounted on the body.

According to another aspect, the present invention provides an image forming device including a body and the above described liquid cartridge that is detachably mounted on the body for supplying liquid to the body. The body includes a liquid ejecting head that ejects the liquid supplied from the liquid cartridge; a body controller that controls the liquid ejecting head; a body side detecting unit that detects whether or not the liquid cartridge is mounted on the body; and a first contact point. The liquid cartridge further includes: a cartridge controller and a second contact point that is configured to contact the first contact point to establish a signal transmission path between the body controller and the cartridge controller when the ink cartridge is mounted on the body. The cartridge controller reads the time length data from the storing unit and controls the second opening/closing unit to switch from the closed state to the open state when the prescribed time has elapsed after the body side detecting unit detects that the liquid cartridge is mounted on the body.

According to another aspect, the present invention provides an image forming device including a body and the above described liquid cartridge that is detachably mounted on the body for supplying liquid to the body. The body includes a liquid ejecting head that ejects the liquid supplied from the liquid cartridge; a body controller that controls the liquid ejecting head; and a first contact point. The liquid cartridge further includes: a cartridge side detecting unit that detects whether or not the liquid cartridge is mounted on the body; a cartridge controller; and a second contact point that is configured to contact the first contact point to establish a signal transmission path between the body controller and the cartridge controller when the ink cartridge is mounted on the body. The cartridge controller reads the time length data from the storing unit and controls the second opening/closing unit to switch from the closed state to the open state when the prescribed time has elapsed after the cartridge side detecting unit detects that the liquid cartridge is mounted on the body.

According to another aspect, the present invention provides an image forming device including a body and the above described liquid cartridge that is detachably mounted on the body for supplying liquid to the body. The body includes a liquid ejecting head that ejects the liquid supplied from the liquid cartridge; a body controller that controls the liquid ejecting head; a body side detecting unit that detects whether or not the liquid cartridge is mounted on the body; and a first contact point. The liquid cartridge further includes a second contact point that is configured to contact the first contact point to establish a signal transmission path between the body controller and the storage unit when the ink cartridge is mounted on the body. The body controller reads the time length data from the storing unit when the cartridge is mounted on the body and controls the second opening/closing unit to switch from the closed state to the open state when the prescribed time has elapsed after the body side detecting unit detects that the liquid cartridge is mounted on the body.

According to another aspect, the present invention provides an image forming device including a body and the above described liquid cartridge that is detachably mounted on the body for supplying liquid to the body. The body includes a liquid ejecting head that ejects the liquid supplied from the liquid cartridge; a body controller that controls the liquid ejecting head; and a first contact point. The liquid cartridge further includes a cartridge side detecting unit that detects whether or not the liquid cartridge is mounted on the body, and a second contact point that is configured to contact the first contact point to establish a signal transmission path between the body controller, and the storage unit and the cartridge side detecting unit when the ink cartridge is mounted on the body. The body controller reads the time length data from the storing unit when the cartridge is mounted on the body and controls the second opening/closing unit to switch from the closed state to the open state when the prescribed time has elapsed after the cartridge side detecting unit detects that the liquid cartridge is mounted on the body.

According to another aspect, the present invention provides a liquid cartridge including a liquid accommodating unit, a liquid delivery path, a first opening/closing unit, a second opening/closing unit, a storing unit, and a cartridge controller. The liquid accommodating unit is configured to accommodate liquid therein. The liquid delivery path is in fluid communication with the liquid accommodating unit and supplies liquid externally from the liquid accommodating unit, the liquid delivery path having a first portion and a second portion positioned between the liquid accommodating unit and the first portion. The first opening/closing unit is configured so as to be capable of being switched between an open state in which the first portion is opened and a closed state in which the first portion is closed. The second opening/closing unit is configured so as to be capable of being switched between an open state in which the second portion is opened and a closed state in which the second portion is closed. The storing unit is configured to store time length data indicating a length of a prescribed time. The length of the prescribed time represents a recommended value of a time period between a first time point and a second time point. The first time point indicates a time point at which the first opening/closing unit is switched from the closed state to the open state. The second time point indicates a time point at which the second opening/closing unit is switched from the closed state to the open state. The cartridge controller controls the second opening/closing unit to switch from the closed state to the open state when the prescribed time has elapsed after the first opening/closing unit is switched from the closed state to the open state.

### BRIEF DESCRIPTION OF THE DRAWINGS

In the drawings:

FIG. 1 is a perspective view showing the external appearance of an inkjet printer according to a first embodiment of the present invention;

FIG. 2(a) is a side cross-sectional view showing the internal structure of the inkjet printer in FIG. 1;

FIG. 2(b) is a schematic diagram showing an ink supplying system of the inkjet printer in FIG. 1;

FIG. 3 is a perspective view of an ink cartridge according to the first embodiment of the present invention;

FIG. 4 is a schematic diagram showing the internal structure of the ink cartridge in FIG. 3;

FIG. 5(a) is a partial cross-sectional view of the ink cartridge when a first valve is closed;

FIG. 5(b) is a partial cross-sectional view of the ink cartridge when the first valve is opened;

FIG. 6 is a perspective view of a second valve according to the first embodiment of the present invention;

FIG. 7(a) is a cross-sectional view of the second valve and an actuator when an ink channel of a tube is opened;

FIG. 7(b) is a cross-sectional view of the second valve and the actuator when the ink channel of the tube is closed;

FIG. 8 is a block diagram showing the electrical structure of the inkjet printer and ink cartridge according to the first embodiment;

FIGS. 9(a) and 9(b) are partial cross-sectional views showing the state how the ink cartridge is mounted in a mounting unit of the printer, wherein FIG. 9(a) shows the state prior to when the ink cartridge is mounted in the mounting unit, and FIG. 9(b) shows the state how the ink cartridge is mounted in the mounting unit;

FIG. 10 is a flowchart illustrating steps in a control process performed by controllers in the inkjet printer and the ink cartridge according to the first embodiment when the ink cartridge is, mounted in the mounting unit of the printer;

FIG. 11 is a block diagram showing the electrical structure of an inkjet printer and an ink cartridge according to a third variation of the first embodiment;

FIG. 12 is a block diagram showing the electrical structure of an inkjet printer and an ink cartridge according to a second embodiment; and

FIG. 13 is a block diagram showing the electrical structure of an inkjet printer and an ink cartridge according to a first variation of the second embodiment.

### DETAILED DESCRIPTION

Next, embodiments of the present invention will be described while referring to the accompanying drawings.

### First Embodiment

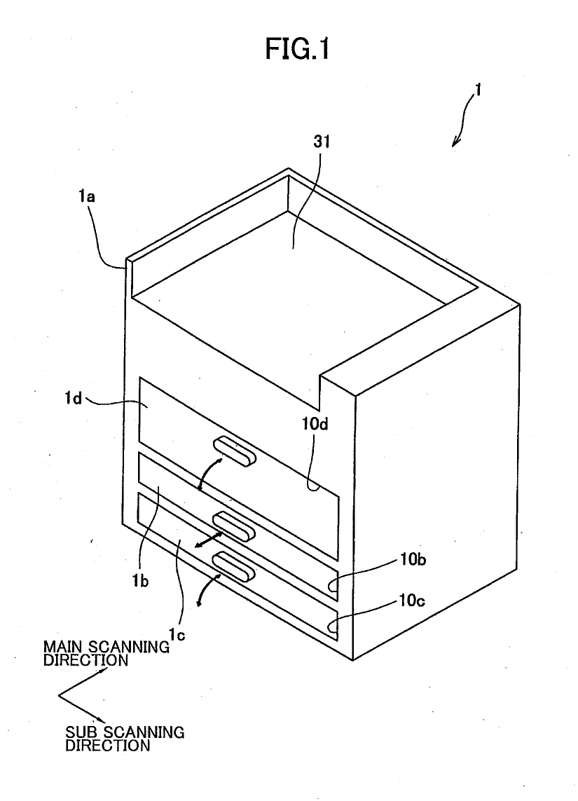

In a first embodiment of the present invention, the recording device is an inkjet printer 1 (image forming device). As shown in FIG. 1, the inkjet printer 1 has a casing 1a formed in the shape of a rectangular parallelepiped. Three openings 10d, 10b, and 10c are formed in order from top to bottom in the front surface of the casing 1a (the surface on the near side in FIG. 1). Doors 1d and 1c are disposed in the openings 10d and 10c, respectively, so as to be flush with the front surface of the casing 1a. The doors 1d and 1c can be opened and closed about a horizontal axis passing through their respective lower edges. A paper supply unit 1b is inserted into the opening 10b. A paper discharging unit 31 is provided on the top of the casing 1a. The door 1d is disposed on the same level vertically as a conveying unit 21 described later, facing the conveying unit 21 in a main scanning direction of the inkjet printer 1 (toward the far side in FIG. 1).

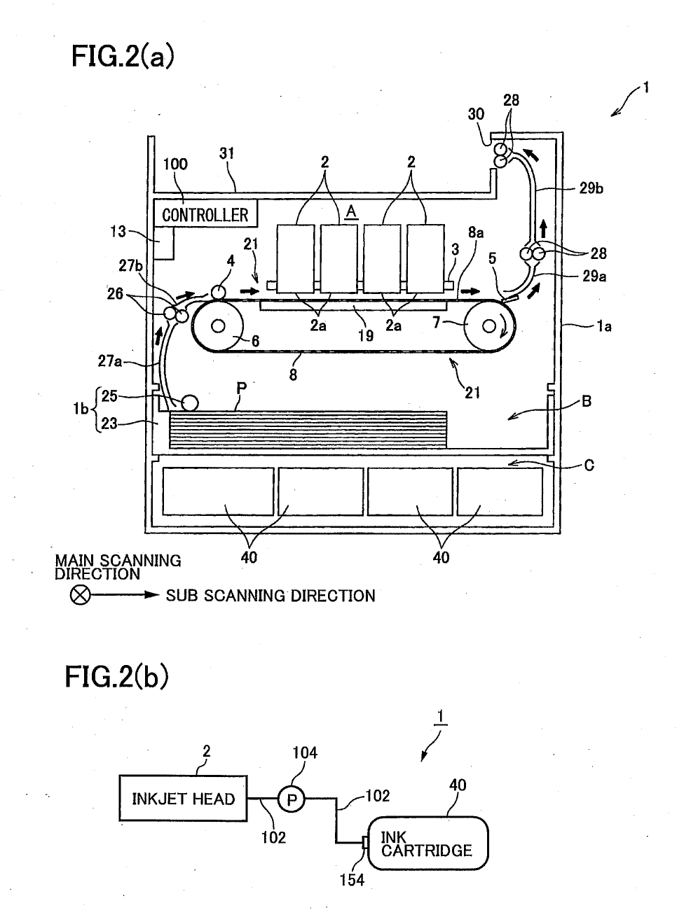

Next, the internal structure of the inkjet printer 1 will be described with reference to FIGS. 2(a) and 2(b). As shown in FIG. 2(a), the interior of the casing 1a is partitioned into three spaces A-C in order from top to bottom. Within the space A are disposed four inkjet heads 2 (liquid ejecting head) that eject ink droplets in the respective colors magenta, cyan, yellow, and black; and the conveying unit 21. The paper supply unit 1b is disposed in the space B, and four ink cartridges 40 (liquid cartridge) are disposed in the space C.

The paper supply unit 1b and the four ink cartridges 40 are mounted in and removed from the casing 1a along the main scanning direction (the direction orthogonal to the surface of the paper in FIG. 2(a)). In the embodiment, a sub scanning direction is a direction in which a sheet P is conveyed by the conveying unit 21, while the main scanning direction is a horizontal direction orthogonal to the sub scanning direction. The inkjet printer 1 is further provided with a controller 100 (body controller) that controls the paper supply unit 1b, conveying unit 21, and inkjet heads 2.

The bold arrows in FIG. 2(a) indicate a paper-conveying path formed in the inkjet printer 1 along which sheets P are conveyed from the paper supply unit 1b to the paper discharging unit 31. The paper supply unit 1b includes a paper tray 23 capable of accommodating a plurality of sheets P, and a feeding roller 25 mounted on the paper tray 23. When a drive force is applied to the feeding roller 25 by a feeding motor (not shown) controlled by the controller 100, the feeding roller 25 feeds the topmost sheet P accommodated in the paper tray 23. The sheet P fed by the feeding roller 25 is guided along guides 27a and 27b, and a pair of conveying rollers 26 grip and convey the sheet P to the conveying unit 21.

As shown in FIG. 2(a), the conveying unit 21 includes two belt rollers 6 and 7 and an endless conveying belt 8 looped around both belt rollers 6 and 7 and stretched taut therebetween. The belt roller 7 is a drive roller that is rotated clockwise in FIG. 2(a) when the controller 100 controls a conveying motor (not shown) to apply a drive force to a shaft of the belt roller 7. The belt roller 6 is a follow roller that also rotates clockwise in FIG. 2(a) when the conveying belt 8 is circulated by the rotating belt roller 7.

An outer surface 8a of the conveying belt 8 is coated with silicone to give the outer surface 8a tackiness. A nip roller 4 is disposed along the paper-conveying path at a position confronting the belt roller 6 through the conveying belt 8. The nip roller 4 holds the sheet P conveyed from the paper supply unit 1b against the outer surface 8a of the conveying belt 8. Once pressed against the outer surface 8a, the sheet P is conveyed rightward in FIG. 2(a) (in the paper-conveying direction) while being held on the outer surface 8a by the tacky coating.

A separating plate 5 is also disposed on the paper-conveying path at a position opposing the belt roller 7 through the conveying belt 8. The separating plate 5 functions to separate the sheet P from the outer surface 8a of the conveying belt 8. Once separated, the sheet P is guided toward pairs of conveying rollers 28 by guides 29a and 29b, and the conveying rollers 28 grip and discharge the sheet P onto the paper discharging unit 31 through an opening 12 formed in the top of the casing 1a. A feeding motor (not shown) controlled by the controller 100 applies a drive force to one of the conveying rollers 28 in each pair.

The four inkjet heads 2 are supported in the casing 1a by means of a frame 3 and are juxtaposed in the sub scanning direction. Each inkjet head 2 is elongated in the main scanning direction. In other words, the inkjet printer 1 of the embodiment is a line-type color inkjet printer. Each inkjet head 2 has a laminated body formed by bonding a channel unit and a plurality of actuators (both not shown in the drawings) together. The channel unit has a plurality of ink channels and a plurality of pressure chambers formed therein, and the actuators apply pressure to ink in the pressure chambers. The bottom surface of each inkjet head 2 is an ejection surface 2a. A plurality of ejection holes (not shown) for ejecting ink droplets from the plurality of pressure chambers are formed in each ejection surface 2a.

A platen 19 having a substantially rectangular parallelepiped shape is disposed within the loop of the conveying belt 8 at a position opposite the four inkjet heads 2. The top surface of the platen 19 contacts the inner surface of the conveying belt 8 on the upper portion of the loop and supports this upper loop portion from the inner surface of the conveying belt 8. Accordingly, the outer surface 8a on the upper loop portion of the conveying belt 8 is maintained parallel and opposite the ejection surfaces 2a, with a slight gap formed between the ejection surfaces 2a and the outer surface 8a. This gap constitutes part of the paper-conveying path. As a sheet P held on the outer surface 8a of the conveying belt 8 is conveyed directly beneath the four inkjet heads 2 in sequence, the inkjet heads 2 are controlled by the controller 100 to eject ink droplets of their respective colors onto the top surface of the sheet P, thereby forming a desired color image on the sheet P.

Of the four ink cartridges 40, the leftmost ink cartridge 40 shown in FIG. 2(a) stores black ink. As shown in FIG. 2(a), the leftmost ink cartridge 40 has a larger dimension in the sub scanning direction than the other three ink cartridges 40 and, hence, a greater ink capacity than the other three ink cartridges 40. The remaining three ink cartridges 40 possess an identical ink capacity and store ink in the colors magenta, cyan, and yellow, respectively.

To replace one of the ink cartridges 40, the operator opens the door 1c on the casing 1a, removes the ink cartridge 40 from the printer body, and mounts a new ink cartridge 40 in the printer body. Although the ink cartridges 40 are mounted individually in the printer body in the embodiment, the four ink cartridges 40 may instead be placed in a single cartridge tray to form an ink unit, and the entire ink unit can be mounted in the printer body.

Next will be described ink supplying systems provided in the inkjet printer 1. Four ink supplying systems are provided for the four inkjet print heads 2, respectively. The ink supplying systems have the same configurations with one another. One of the ink supplying systems will be described below while referring to FIG. 2(b), but the following description is in common to the other ink supplying systems.

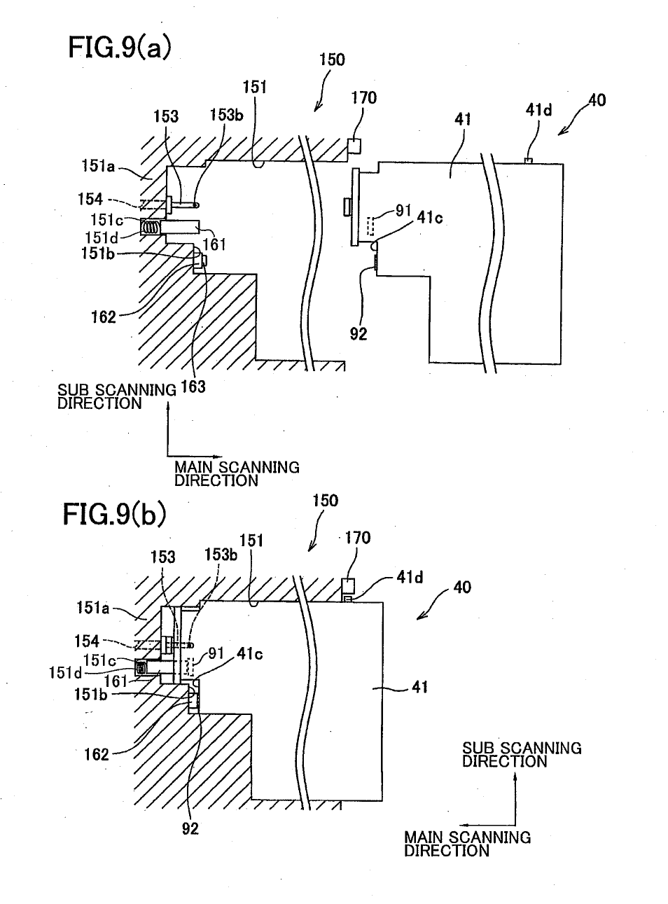

As shown in FIG. 2(b), in each ink supplying system, one inkjet head 2 is connected via a flexible tube 102 (ink supplying path) to one ink supply channel 154 described later (see FIG. 9(a)). The ink channels formed in the inkjet head 2 are in fluid communication with the flexible tube 102. A pump 104 (ink discharging unit, ink forcibly supplying unit) is provided in the midway portion of the tube 102 connecting the inkjet head 2 and the ink supply channel 154. When one ink cartridge 40 is mounted in the body of the printer (the casing 1a), the ink cartridge 40 is connected to one ink supply channel 154 so that ink can be supplied from the ink cartridge 40 to the corresponding inkjet head 2. The pump 104 is controlled by the controller 100 to forcibly supply ink from the ink cartridge 40 to the inkjet head 2.

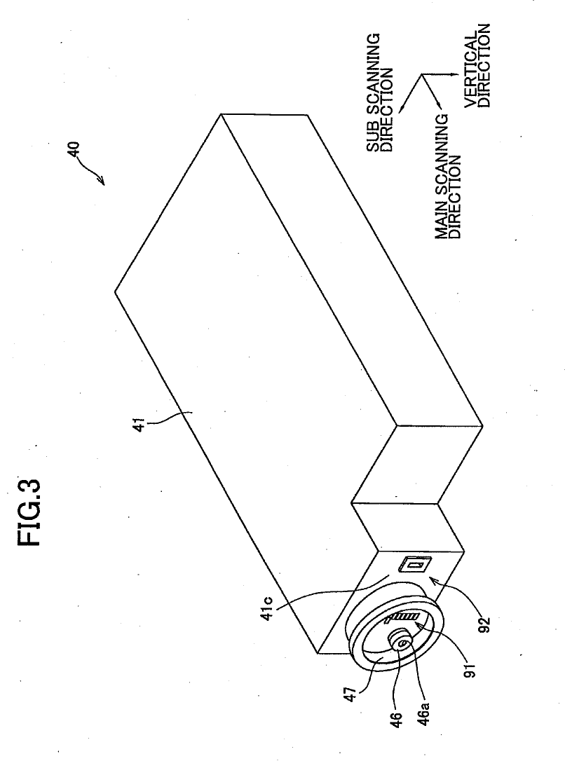

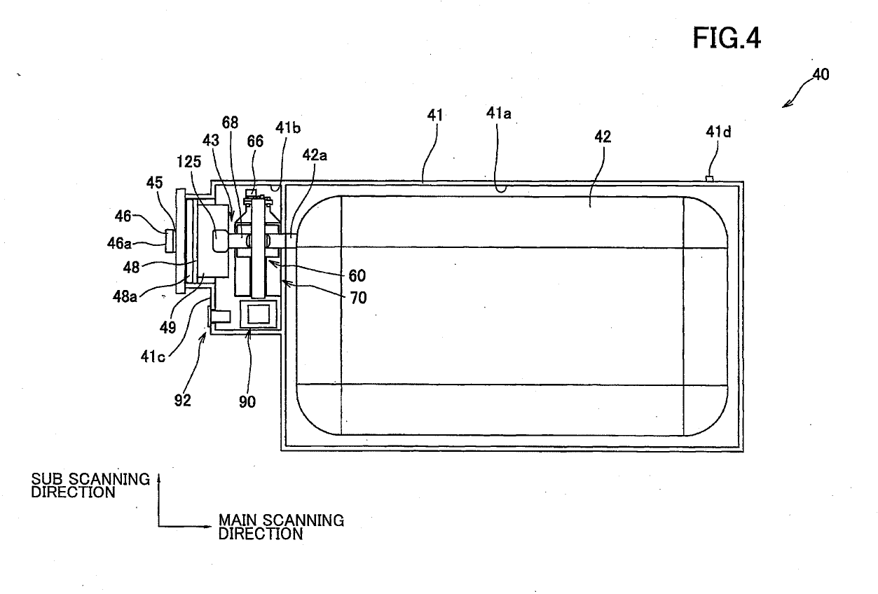

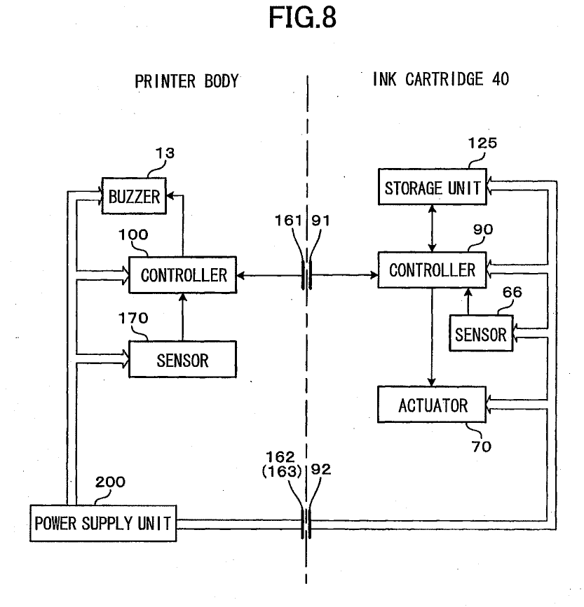

Next, the ink cartridges 40 will be described with reference to FIGS. 3 through 8. Note that the white bold arrows in FIG. 8 indicate power supply lines, while the normal arrows indicate signal lines. As shown in FIGS. 3 and 4, each ink cartridge 40 includes a case 41 having a substantially parallelepiped shape. As shown in FIG. 4, inside the case 41 are provided: an ink bag 42 (ink accommodating unit) that is filled with ink; an ink delivery tube 43 in communication with the ink bag 42 on one end; a first valve 50 (first opening/closing unit); a second valve 60 (second opening/closing unit); an actuator 70 (drive unit); a storage unit 125; and a controller 90 (cartridge controller) for controlling the actuator 70.

As shown in FIG. 4, the interior of the case 41 is partitioned into two chambers 41a and 41b. The ink bag 42 is provided in the chamber 41a on the right in FIG. 4, while the ink delivery tube 43, first valve 50, second valve 60, actuator 70, controller 90, and storage unit 125 are disposed in the other chamber 41b. An air communication through-hole (not shown) is formed through the case 41 to communicate the interior of the case 41 to the outside. With this configuration, the ink bag 42 is applied with an atmospheric pressure. So, when the ink cartridge 40 is mounted in the inkjet printer 1, ink in the inkjet head 2 is applied with a negative pressure that is generated due to the pressure head difference between the inkjet head 2 and the ink bag 42.

As mentioned earlier, the ink cartridge 40 for accommodating black ink is larger in size and has greater ink storage capacity than the other three ink cartridges 40, but this difference is simply reflected in the chamber 41a and ink bag 42 being larger in the sub scanning direction. Since the four ink cartridges 40 have essentially the same structure, the following description of the ink cartridge 40 will pertain to all ink cartridges 40.

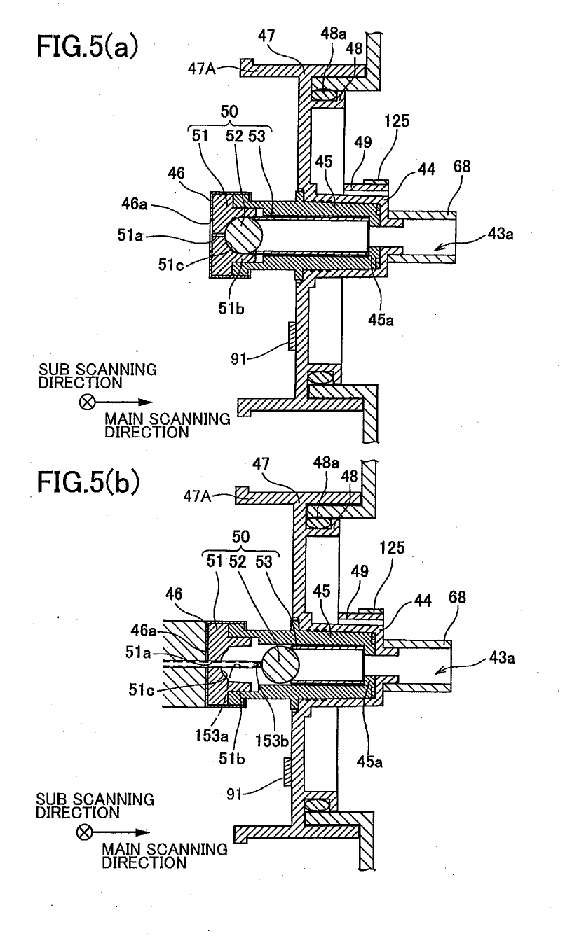

As shown in FIGS. 4 and 5, the ink delivery tube 43 includes an resiliently deformable tube 68 that is connected to a connector 42a of the ink bag 42, a tube 44 connected to the tube 68, and a tube 45 fitted into the tube 44. An ink channel 43a (ink delivery path, first portion, and second portion) is formed inside the ink delivery tube 43. The ink channel 43a extends in the main scanning direction and is in communication with the ink bag 42.

As shown in FIG. 5, an annular flange 47 is formed on one end of the tube 44. As shown in FIGS. 4 and 5, the annular flange 47 is formed with a circular cylinder part 47A surrounding the outer periphery of the annular flange 47. The annular flange 47 is further formed with an annular protrusion 48. An O-ring 48a is provided around the outer periphery of the annular protrusion 48 and seals the gap between the case 41 and the annular protrusion 48, as shown in FIG. 4. The annular flange 47 of this embodiment forms part of the wall defining the chamber 41b and constitutes part of the case 41.

As shown in FIG. 4, the storage unit 125 is provided on a plate-shaped member 49. The plate-shaped member 49 is fixed to the cylindrical body 48 on the side opposite the annular flange 47. The storage unit 125 is connected to the controller 90 and stores data specifying a predetermined wait time depending on ink capacity of each ink cartridge 40, and a serial code indicating the type of the ink cartridge 40. The wait time is the time required for fluctuations in ink pressure within the ink bag 42 to subside when the ink cartridge 40 is mounted in a mounting unit 150 described later.

Since the ink cartridge 40 is moved when the user mounts the ink cartridge 40 in the mounting unit 150, this movement can produce a change in ink pressure within the ink bag 42. If the pressure change is transferred to the inkjet head 2 via the ink supply channel 154, there is a possibility that the meniscuses formed on ejection holes formed in the inkjet head 2 will break.

However, as will be described later in greater detail, the inkjet printer 1 according to this embodiment changes the second valve 60 from a closed state to an open state to open the ink supply channel 154 linking the ink bag 42 in the ink cartridge 40 to the inkjet head 2 a prescribed time after the ink cartridge 40 is mounted in the mounting unit 150. Therefore, ink in the ink bag 42 is not supplied to the inkjet head 2 until the change in ink pressure during mounting has abated, thereby reducing the possibility that meniscuses in the ejection holes will break.

If this prescribed time is too short, the ink in the ink bag 42 will be supplied to the inkjet head 2 before the ink pressure change has abated, adversely affecting the meniscuses. However, setting the prescribed time too long is also not preferable because the user must wait a longer time before being able to print. Therefore, in this embodiment a recommended value for this prescribed time is calculated by imagining the maximum pressure change that could occur when a user mounts the ink cartridge 40 in the mounting unit 150 and the time required for this fluctuation in ink pressure to abate to a level that will not break the meniscuses. The time is stored in the storage unit 125 as the recommended value for the prescribed time. This method achieves the best balance between preventing breakage of ink meniscuses and reducing the user's wait time for performing recording operations.

When mounting the ink cartridge 40 in the mounting unit 150, a hollow needle 153 described later being inserted into the first valve 50 will likely generate a change in ink pressure within the ink bag 42. When considering a prescribed time for allowing the change in pressure caused by this additional factor to abate, the prescribed time should be set as a wait time after the first valve 50 has switched to an open state (when the change in pressure occurred). As will be described later, since the first valve 50 is switched to the open state at the same time the ink cartridge 40 is completely mounted in the mounting unit 150 in this embodiment, the changes in ink pressure begin to subside from this point in time. Therefore, even though there are two causes of pressure change, the prescribed time should be set based on this point in time.

The storage units 125 in the three ink cartridges 40, excluding the ink cartridge 40 that stores black ink, store data indicating a first prescribed time. The storage unit 125 of the ink cartridge 40 storing black ink stores data indicating a second prescribed time, which is longer than the first prescribed time. In other words, the storage units 125 store prescribed times that are set longer for larger capacities of ink. Note that, the recommended value for the prescribed time (first and second prescribed times) is determined based on an initial ink quantity of the new ink cartridge 40 and does not change even if the ink quantity remaining in the ink cartridge 40 is changed. In addition, an external device other than the inkjet printer 1 can easily be used to overwrite data indicating the quantity of ink in the ink cartridge 40. Therefore, if an ink cartridge 40 that has run out of ink is refilled with a quantity of ink different from the initial ink quantity, an external device can be used to overwrite data in the storage unit 125 indicating the ink quantity in order to reflect this change in specification. By providing the storage unit 125 described above in the ink cartridge 40 and storing all of the data described above therein, it is possible to reduce the required storage capacity of a storage unit in the printer body.

As indicated in FIGS. 3 and 5, a contact point 91 of a signal transmission system is formed on the outer surface of the annular flange 47. The contact point 91 is juxtaposed with the ink outlet 46a along the sub scanning direction. As shown in FIG. 8, the contact point 91 is connected to the controller 90. As a variation of the embodiment, the contact point 91 can be disposed at any position, provided that the contact point 91 is not positioned vertically below the ink outlet 46a. Disposing the contact point 91 of the signal transmission system at a position that is not directly beneath the ink outlet 46a can prevent ink from dripping out of the ink outlet 46a onto the contact point 91.

In addition, a power input unit (contact point) 92 of a power transmission system is disposed on a side surface of the case 41 on the ink outlet 46a side. A stepped surface 41c is formed on the case 41 so that the case 41 is recessed from the annular flange 47 toward the ink bag 42 in the main scanning direction between the ink outlet 46a and the power input unit 92. The power input unit 92 is provided on the stepped surface 41c and is positioned on the opposite side of the ink outlet 46a with respect to the contact point 91 in the sub scanning direction. In other words, the power input unit 92 is separated farther from the ink outlet 46a in the sub scanning direction than is the contact point 91. As shown in FIG. 8, the power input unit 92 is electrically connected to the controller 90, the storage unit 125 and the actuator 70. Through an electrical connection with a power output part 162 in the recording device 1 side described later, the power input unit 92 supplies electricity to the controller 90, the storage unit 125, the actuator 70, and a photosensor 66 (opening/closing detecting unit) described later. As a variation of the embodiment, the power input unit 92 may be disposed at any position, provided that the position is not directly beneath the ink outlet 46a.

Disposing the power input unit 92 of the power transmission system at a position not directly beneath the ink outlet 46a in this way prevents ink dripping out of the ink outlet 46a from depositing on the power input unit 92. Further, by separating the power input unit 92 from the ink outlet 46a even farther than the contact point 91, it is even less likely that ink will become deposited on the power input unit 92, thereby ensuring that the power input unit 92 does not short-circuit and damage the controller 90 or the like. Further, by forming the stepped surface 41c between the power input unit 92 and ink outlet 46a, the power input unit 92 and ink outlet 46a are separated considerably in the main scanning direction as well as the sub scanning direction, thereby further ensuring that ink does not become deposited on the power input unit 92.

As shown in FIG. 5(a), the first valve 50 is disposed inside the tube 45 of the ink delivery tube 43. The first valve 50 includes a flexible sealing member 51 for sealing the opening formed in the left end of the tube 45, a spherical member 52, and a coil spring 53. A cover 46 is provided over one end of the tube 45. The cover 46 prevents the sealing member 51 from coming out of the tube 45. An ink outlet 46a is formed in the cover 46.

One end of the coil spring 53 contacts the spherical member 52, and the other end contacts a stepped part 45a formed on the inner end of the tube 45 for constantly urging the spherical member 52 toward the sealing member 51. In the embodiment, the coil spring 53 is used as an urging member, but the urging member may be implemented by means other than a coil spring, provided that the spherical member 52 is urged toward the sealing member 51.

The sealing member 51 is configured of an elastic member formed of rubber or the like. The sealing member 51 has a slit 51a penetrating the center of the sealing member 51 in the main scanning direction, an annular protrusion 51b that can be fitted into the end of the tube 45, and a curved part 51c constituting the surface of the sealing member 51 opposing the spherical member 52 in the region surrounded by the annular protrusion 51b. The curved part 51c has a shape that conforms to the outer surface of the spherical member 52. The cross-sectional diameter of the slit 51a is slightly smaller than the diameter of the hollow needle 153 described later. Accordingly, when the hollow needle 153 is inserted into the slit 51a, the sealing member 51 elastically deforms so that the inner surface of the slit 51a is in close contact with the outer surface of the hollow needle 153, preventing ink from leaking between the slit 51a and the hollow needle 153.

The inner diameter of the annular protrusion 51b is slightly smaller than the diameter of the spherical member 52, and the slit 51a is sealed when the spherical member 52 contacts the inner surface of the annular protrusion 51b. More specifically, the slit 51a is sealed through contact between the spherical member 52 and curved part 51c. Further, the slit 51a formed in the sealing member 51 facilitates insertion of the hollow needle 153 into the sealing member 51. Further, because the slit 31a is formed in the sealing member 51, although the hollow needle 153 scrapes against the sealing member 51 when being inserted therein, shaving matter from the sealing member 51 is restricted from being generated and entering the hollow needle 153. Therefore, the shaving matter from the sealing member 51 can be prevented from entering the ink channel of the inkjet head 2.

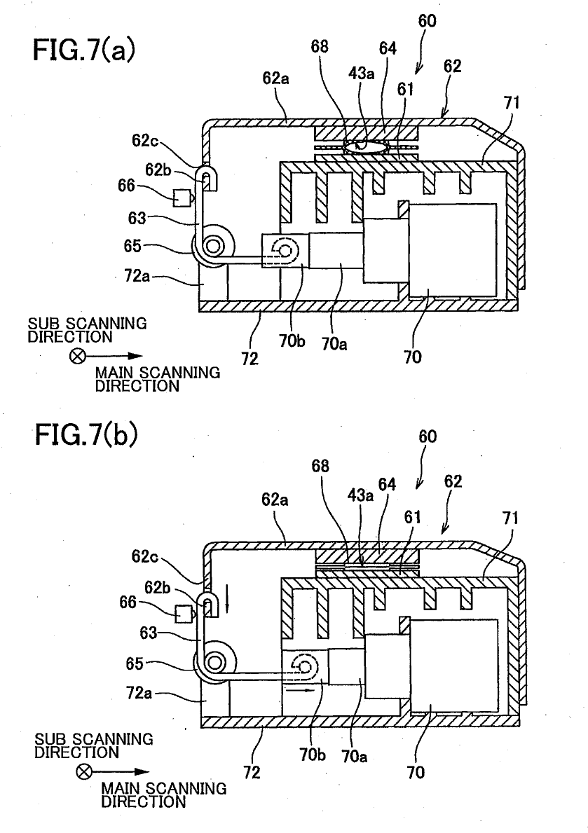

With this construction, when the hollow needle 153 is inserted through the ink outlet 46a into the slit 51a, the distal end of the hollow needle 153 contacts the spherical member 52 and pushes the spherical member 52 away from the curved part 51c and annular protrusion 51b, as shown in FIG. 7(b). At this time, the first valve 50 switches from a closed state to the open state. Further, a hole 153b formed in the hollow needle 153 described later has passed through the slit 51a when the first valve 50 is in the open state. So, the hollow needle 153 is in communication with the ink channel 43a. Conversely, when the hollow needle 153 moves in the opposite direction for being extracted from the slit 51a, the urging force of the coil spring 53 moves the spherical member 52 toward the annular protrusion 51b. When the spherical member 52 comes into contact with the annular protrusion 51b, the first valve 50 is shifted from the open state back to the closed state. As the hollow needle 153 is further pulled out of the slit 51a, the spherical member 52 tightly contacts the curved part 51c. In this way, the first valve 50 takes on either the open state for allowing communication within the ink delivery tube 43 or the closed state for interrupting communication within the ink delivery tube 43 based on insertion or retraction of the hollow needle 153. Further, since the first valve 50 is provided with the coil spring 53 for urging the spherical member 52 toward the sealing member 51, the first valve 50 can suppress ink from leaking out of the first valve 50 through a simple construction.

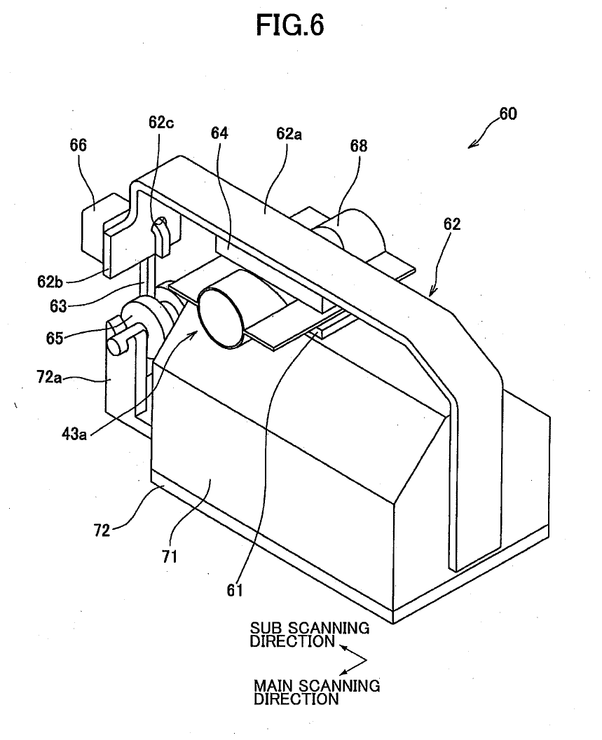

As shown in FIGS. 6 through 7(b), the second valve 60 comprise a rigid plate 61, a leaf spring 62 including a middle portion 62a, and the tube 68 sandwiched between the rigid plate 61 and the middle portion 62a of the leaf spring 62. The second valve 60 further includes a wire 63 coupled to the actuator 70 at a first end thereof and to the leaf spring 62 at a second end thereof. The rigid member 61 is disposed on a cover 71 covering the actuator 70.

The leaf spring 62 is bent following the outer shape of the cover 71. A first end of the leaf spring 62 is fixed to one side face of the cover 71, and a second end of the leaf spring 62 is configured to move freely. The middle portion 62a of the leaf spring 62 faces the upper face of the cover 71 and extends substantially parallel to the rigid plate 61 and the upper face of the cover 71. A plate shaped elastic member 64 made of rubber or the like is disposed between the middle portion 62a and the tube 68. A protrusion 62b protrudes from the second end of the leaf spring 62 in an extending direction of the tube 68. Also, an opening 62c is formed through a portion of the leaf spring 62 adjacent to the second end of the leaf spring 62. The second end of the wire 63 is passed through the opening 62c, such that the wire 63 and the leaf spring 62 are coupled.

The actuator 70 includes a solenoid fixed to a base 72, and the solenoid is configured, such that a movable core 70a is linearly advanced and retracted. The actuator 70 is driven such that when electric power is supplied thereto the movable core 70a is advanced and when the electric power is no longer supplied thereto the movable core 70a is retracted. Also, the actuator 70 is covered by the cover 71 fixed to the base 72. A pair of supporting portions 72a extends from the base 72 at a position facing the second end of the leaf spring 62. A pulley 65 is rotatably supported by the pair of supporting portions 72a. A fixing portion 70b is provided at the tip portion of the movable core 70a to which the first end of the wire 63 is fixed. The wire 63 is disposed so as to be bent over the pulley 65 and such that the second end of the leaf spring 62 moves in accordance with operations of the actuator 70.

When the ink cartridge 40 is removed from the mounting unit 150, the electric connection between the contact point 91 and the contact point 161 is cut off, and electric power is not supplied to the actuator 70. The movable core 70a is retracted from the position shown in FIG. 7(a) to the position shown in FIG. 7(b), and the second end of the leaf spring 62 moves downwards in FIGS. 7(a) and 7(b) by way of the wire 63. In other words, the second end of the leaf spring 62 moves in such a direction that the tube 48 is pressed against the rigid plate 61 by the middle portion 62a of the leaf spring 62. Accordingly, the leaf spring 62 is elastically deformed so as to press the tube 68 between the middle portion 62a and the rigid plate 61. The tube 68 is elastically deformed in its radial direction to become flat, and thereby the second valve 60 becomes a close state, in which the second valve 60 prevents ink in the ink outlet path 43a from flowing via the second valve 60. When the ink cartridge 40 is mounted to the mounting portion 150, the contact point 91 and the contact point 161 are electrically connected, and electric power is supplied to the actuator 70. The movable core 70a is advanced from the position shown in FIG. 7(b) to the position shown in FIG. 7(a), and the middle portion 62a moves by the elastic force of the leaf spring 62 itself in a direction opposite to the direction to press the tube 48 against the rigid plate 61, i.e., the second end of the leaf spring 62 moves upwards in FIGS. 7(a) and 7(b). Accordingly, pressing force applied to the tube 68 between the middle portion 62a and the rigid plate 61 is released, thereby the second valve 60 becomes an open state, in which the second valve 60 allows ink in the ink channel 43a to flow via the second valve 60.

Thus, the second valve 60 can open and close the ink channel 43a without directly contacting ink in the ink channel 43a. The configuration of the second valve can be simplified. Disposing the wire 63 so as to be bent over the pulley 65 enables the second valve 60 and the actuator 70 to be arranged in a compact manner. Damage to the tube 68 due to opening and closing of the ink channel 43a by the second valve 60 is reduced because the elastic member 64 is disposed between the leaf spring 62 and the tube 68. Further, when the electric power is not supplied to the actuator 70, the movable core 70a is retracted. Hence, communication in the ink channel 43a is blocked.

The photosensor 66 is a reflective-type optical sensor. The photosensor 66 is provided in the chamber 41b of the case 41 and connected to the controller 90. The photosensor 66 is disposed in a position not opposing the protrusion 62b when the second valve 60 does not block communication with the ink channel 43a, as shown in FIG. 7(a), and opposing the protrusion 62b when the second valve 60 blocks communication within the ink channel 43a. The photosensor 66 has a light-emitting element and a light-receiving element and outputs signals to the controller 90 based on whether the light-receiving element is receiving light. Specifically, the photosensor 66 outputs a signal A when the light-receiving element receives light and a signal B, different from the signal A, when the light-receiving element does not receive light.

Hence, when the photosensor 66 opposes the protrusion 62b, the photosensor 66 outputs the signal A to the controller 90 because the light outputted from the light-emitting element is reflected off the protrusion 62b and received by the light-receiving element. Based on the signal A, the controller 90 can determine that the second valve 60 is in the closed state. On the other hand, when the photosensor 66 does not confront the protrusion 62b, the photosensor 66 outputs the signal B to the controller 90 because the light outputted from the light-emitting element is not reflected off the protrusion 62b and, thus, not received by the light-receiving element. Based on this signal B, the controller 90 can determine that the second valve 60 is in the open state.

In other words, the signal A outputted by the photosensor 66 corresponds to the closed state of the second valve 60, and the signal B corresponds to the open state of the second valve 60. Since the open and closed state of the second valve 60 can be detected using the sensor 66 to detect mechanical displacement of the second valve 60 (leaf spring 62), the open and closed state of the second valve 60 can be detected more reliably.

Next, mounting units 150 formed in the body of the inkjet printer 1 will be described with reference to FIGS. 8 and 9. Four of the mounting units 150 juxtaposed in the sub scanning direction are provided in the printer body for receiving the respective ink cartridges 40 when mounting the ink cartridges 40 in the printer body. Since the mounting units 150 have substantially the same structure, only one of the mounting units 150 will be described below.

As shown in FIG. 9, the mounting unit 150 has a recessed part 151 that conforms to the outer shape of the ink cartridge 40. The recessed part 151 has the most inward part 151a in the main scanning direction. On the most inward part 151a, there are provided the hollow needle 153, the ink supply channel 154, the contact point 161 electrically connected to the controller 100, and the power output part 162 for outputting electricity produced by a power supply unit 200 (see FIG. 6) provided in the printer body.

The hollow needle 153 is fixedly disposed at a position opposite the slit 51a of the mounted ink cartridge 40 and is longitudinally oriented in the main scanning direction. The hollow needle 153 has an inner hollow region 153a in fluid communication with the ink supply channel 154, and a hole 153b formed near the distal end thereof for providing external communication with the hollow region 153a (see also FIG. 5(b)). With this construction, the hollow needle 153 is in a state of communication with the tube 45 side of the ink channel 43a when the ink cartridge 40 is mounted in the printer body and the hole 153b has passed through the slit 51a. However, communication between the hollow needle 153 and the ink channel 43a is interrupted when the hole 153b is inside the slit 51a as the ink cartridge 40 is being removed from the printer body (when the spherical member 52 contacts the annular protrusion 51b). Note that while communication between the hollow needle 153 and ink channel 43a is established when the hole 153b passes through the slit 51a, ink does not flow from the ink bag 42 into the hollow region 153a until the second valve 60 has changed to the open state. Further, the paths from the hole 153b of the hollow needle 153 to the ejection holes in the inkjet head 2 are hermetically sealed channels that are not exposed to the outside air. Accordingly, it is possible to suppress an increase in ink viscosity since the ink in these channels is not exposed to air.

The contact point 161 is juxtaposed with the hollow needle 153 in the sub scanning direction and positioned opposite the contact point 91 of the mounted ink cartridge 40. The contact point 161 is configured of a rod-shaped member that extends in the main scanning direction and is slidably supported in a hole 151c that is formed in the most inward part 151a and that is elongated in the main scanning direction. A spring 151d is provided in the hole 151c and urges the contact point 161 outward from the hole 151c so that the contact point 161 makes an electrical connection with the contact point 91 just prior to the hollow needle 153 being inserted into the sealing member 51 when the ink cartridge 40 is mounted in the printer body and the spherical member 52 is separated from the annular protrusion 51b. In other words, the contact point 161 is electrically connected to the contact point 91 before the first valve 50 changes to the open state. Conversely, when removing the ink cartridge 40 from the body of the inkjet printer 1, the contact point 161 remains electrically connected to the contact point 91 until the ink cartridge 40 is initially pulled outward from the body. The electrical connection between the contact point 161 and contact point 91 establishes a signal transmission path between the controller 100 and controller 90.

The power output part 162 is provided in a stepped surface 151b formed on the most inward part 151a. The power output part 162 is disposed at a position opposing the power input unit 92 of the mounted ink cartridge 40. The power output part 162 also has a contact point 163 that protrudes outward in the main scanning direction. When the ink cartridge 40 is mounted in the printer body, the contact point 163 is inserted into the power input unit 92 and forms an electrical connection with the same. As with the contact point 161, the contact point 163 becomes electrically connected to the power input unit 92 just before the hollow needle 153 enters the sealing member 51.

A reflective-type photosensor 170 (body side detecting unit) is provided on each mounting unit 150 near the opening to the corresponding recessed part 151. The photosensor 170 is connected to the controller 100 and serves to detect the presence of a protrusion 41d formed on the outer surface of the case 41 constituting the ink cartridge 40. The photosensor 170 includes a light-emitting element and a light-receiving element, and outputs signals to the controller 100 based on whether the light-receiving element receives light. Specifically, the photosensor 170 outputs a signal C when the light-receiving element is receiving light and outputs a signal D, different from the signal C, when the light-receiving element is not receiving light.

As shown in FIG. 9(b), the photosensor 170 opposes the protrusion 41d when the ink cartridge 40 is completely mounted in the mounting unit 150 (the first valve 50 changes to the open state at the same time mounting is completed). Since the light outputted from the light-emitting element at this time is reflected off the protrusion 41d and received by the light receiving element, the photosensor 170 outputs the signal C to the controller 100. In this way, the controller 100 can detect when mounting of the ink cartridge 40 in the mounting unit 150 is complete (when the first valve 50 has switched from the closed state to the open state).

When the ink cartridge 40 is removed from the mounting unit 150 (when the first valve 50 is switched from the open state to the closed state), as shown in FIG. 9(a), the photosensor 170 is not positioned opposite the protrusion 41d and, hence, light outputted from the light-emitting element is not reflected off the protrusion 41d and not received by the light-receiving element. Accordingly, the photosensor 170 outputs the signal D to the controller 100, whereby the controller 100 can detect that the ink cartridge 40 is not mounted in the mounting unit 150 (that the first valve 50 is in the closed state).

Hence, the photosensor 170 outputs the signal C to indicate that the ink cartridge 40 is mounted in the mounting unit 150 (the first valve 50 is in the open state) and outputs the signal D to indicate that the ink cartridge 40 is not mounted in the mounting unit 150 (that the first valve 50 is in the closed state). By using the photosensor 170 to detect relative positions of the protrusion 41d and the hollow needle 153 (mounting unit 150), the controller 100 can distinguish when the ink cartridge 40 is mounted in and not mounted in the mounting unit 150 and can detect the open and closed state of the first valve 50. Through this simple construction, it is possible to detect the open and closed state of the first valve 50 without directly detecting the operation of the first valve 50 itself.

As shown in FIGS. 2 and 8, a buzzer 13 is also provided inside the casing 1a. The controller 100 controls the buzzer 13 to emit various sounds intended to notify the user when, for example, an error has occurred in one of the second valve 60 and photosensor 66, data is not stored in the storage unit 125 and the inkjet printer 1 is ready to print.

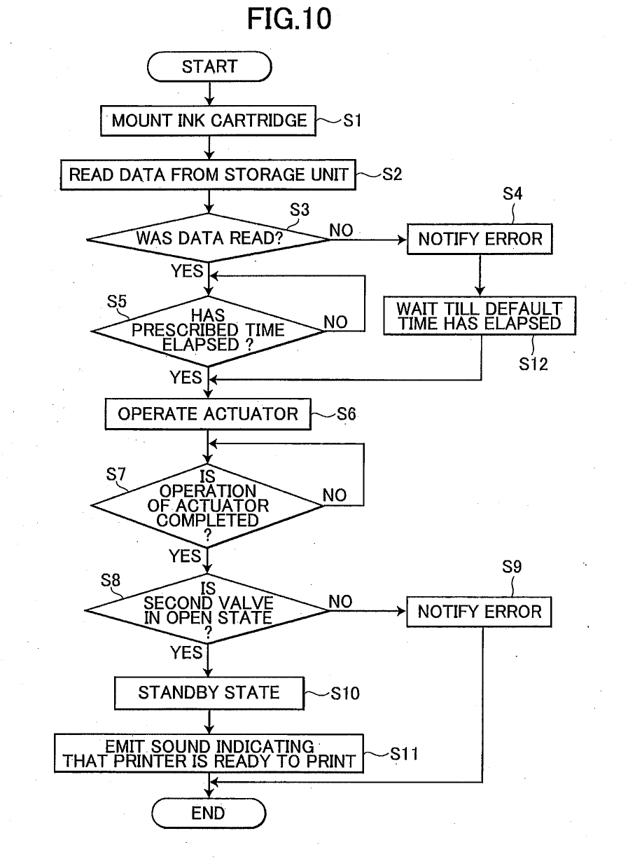

Next, operations performed by the controller 100 of the inkjet printer 1 and the controller 90 of the ink cartridge 40 when an ink cartridge 40 is being mounted into the body of the inkjet printer 1 will be described with reference to FIG. 10. The process described in FIG. 10 begins when the user mounts an ink cartridge 40 into the body of the inkjet printer 1 by opening the door 1c on the printer body and gradually inserting the ink cartridge 40 into the mounting unit 150. During this operation, the hollow needle 153 is gradually inserted into the slit 51a formed in the sealing member 51, and electrical connections are established between the contact point 91 and contact point 161 and between the contact point 163 of the power output part 162 and the power input unit 92. Through these connections, the controller 90 and controller 100 are electrically connected to each other and are capable of exchanging signals. At the same time, power is supplied to the controller 90, actuator 70, storage unit 125, and photosensor 66.

When the ink cartridge 40 is mounted in the mounting unit 150, the photosensor 170 is positioned opposite the protrusion 41d, as shown in FIG. 9(b), and outputs the signal C to the controller 100. In S1 at the beginning of the process in FIG. 8, the controller 100 detects that the ink cartridge 40 has been mounted in the mounting unit 150 upon receiving the signal C from the photosensor 170. As shown in FIG. 5(b), the hollow needle 153 inserted through the slit 51a separates the spherical member 52 from the annular protrusion 51b, moving the first valve 50 from the closed state to the open state. Further, upon detecting that the ink cartridge 40 has been mounted, the controller 100 outputs a signal to the controller 90 indicating the time that the photosensor 170 detected completion of the mounting operation.

Upon receiving the signal from the controller 100 indicating that the ink cartridge 40 was mounted, in S2 the controller 90 reads data from the storage unit 125 indicating the wait time (prescribed time). In S3 the controller 90 determines whether data was read from the storage unit 125 in S2. If the controller 90 was unable to read the above data because the data is not stored in the storage unit 125 (S3: NO), then in S4 the controller 90 outputs a first error signal to the controller 100 and, upon receiving this error signal, the controller 100 controls the buzzer 13 to emit a sound for notifying the user that data is not stored in the storage unit 125.

However, if the controller 90 determines in S3 that data was successfully read from the storage unit 125 (S3: YES), in S5 the controller 90 determines whether the prescribed time has elapsed after mounting was detected. The controller 90 continues to wait while the prescribed time has not elapsed (S5: NO). When the prescribed time has elapsed (55: YES), in S6 the controller 90 outputs a signal to the controller 100 instructing the controller 100 to operate the actuator 70 and, upon receiving this signal, the controller 100 initiates a control operation to operate the actuator 70. The operation of the actuator 70 removes the pressure applied by the middle segment 62a of the leaf spring 62 and the rigid plate 61, thereby shifting the second valve 60 to the open state. When the second valve 60 is in the open state, ink in the ink bag 42 flows through the ink delivery tube 43 into the hollow needle 153. Accordingly, ink is supplied from each ink cartridge 40 to the corresponding inkjet head 2.

In S7 the controller 90 determines whether the operation of the actuator 70 is completed and continues to wait while the operation of the actuator 70 is not completed (S7: NO). The controller 90 determines whether the operation of the actuator 70 has completed by determining whether an operating time stored in the storage unit 125 or in a storage unit (not shown) in the printer body has elapsed since the operation of the actuator 70 was started.

On the other hand, after the controller 90 outputs the first error signal to the controller 100 in S4, in S12 the controller 90 waits till a default time has elapsed after mounting was detected. Date indicating the default time is stored in the storage unit in the printer body. The default time is an enough time required for the fluctuation in ink pressure to abate to a level that will not break the meniscuses and is longer than the prescribed time. After the default time has elapsed, the controller 90 advances to S6.

Hence, if the operating time has elapsed (S7: YES), in S8 the controller 90 determines whether the second valve 60 has shifted from the closed state to the open state. Specifically, the controller 90 determines the state of the second valve 60 based on the signal outputted from the photosensor 66 (signal A indicating the closed state and signal B indicating the open state). If the controller 90 has received the signal A from the photosensor 66, indicating that the second valve 60 is still in the closed state (S8: NO), in S9 the controller 90 outputs a second error signal to the controller 100 and, upon receiving this second error signal, the controller 100 controls the buzzer 13 to emit a sound for notifying the user that an error has occurred with one of the second valve 60, photosensor 66, and the actuator 70. After the buzzer 13 emits the sound in S9, the controller 100 ends the process in FIG. 8. Based on the sound of the buzzer 13, the user replaces the present ink cartridge 40 with a new ink cartridge 40.

However, when the controller 90 has received the signal B from the photosensor 66 (S8: YES), the controller 90 determines that the ink cartridge 40 was properly mounted in the mounting unit 150 and in S10 enters a standby state, i.e., a print-ready state. In S11 the controller 90 outputs a signal to the controller 100 indicating this print-ready state and, upon receiving this signal, the controller 100 controls the buzzer 13 to emit a sound indicating that the inkjet printer 1 is ready to print. At this point, the operation for mounting the ink cartridge 40 is complete.

Next, the operations performed when an ink cartridge 40 is removed from the printer body will be described. When an ink cartridge 40 has run out of ink, for example, the operator opens the door 1c and removes the ink cartridge 40 from the printer body. As the ink cartridge 40 moves out of the printer body, the protrusion 41d moves to a position not opposing the photosensor 170, causing the photosensor 170 to begin outputting the signal D to the controller 100. As a result, the controller 100 recognizes that the first valve 50 is in the closed state and that the ink cartridge 40 is being removed from the printer body. Next, the controller 100 outputs a control signal to the controller 90 for operating the actuator 70. Upon receiving this control signal, the controller 90 controls the actuator 70 in order to compress the tube 68 between the middle segment 62a and the rigid plate 61, thereby changing the second valve 60 from the open state to the closed state and blocking the flow of ink in the ink delivery tube 43. At this time, the photosensor 66 opposes the protrusion 62b and, hence, the photosensor 66 outputs the signal A to the controller 90. Consequently, the controller 90 outputs a signal to the controller 100 indicating the closed state of the second valve 60. The controller 90 continues to output the signal to the controller 100 indicating the closed state of the second valve 60 until the contact point 91 and contact point 161 have separated from each other (i.e., until the hole 153b has passed through the center of the slit 51a).

As the ink cartridge 40 continues to be removed from the mounting unit 150, the hollow needle 153 is withdrawn from the slit 51a of the sealing member 51, and both the contact point 91 and contact point 161 and the power input unit 92 and contact point 163 are disconnected. Thereafter, the user replaces the ink cartridge 40 that was removed from the printer body with a new ink cartridge 40, mounting the new ink cartridge 40 in the printer body according to the procedure described above.

When the inkjet heads 2 are ejecting ink on a sheet P in a printing operation, for example, and one of the actuators 70 is operated through control of the controller 100 to move the corresponding second valve 60 from the open state to the closed state due to a malfunction of the actuator 70, a problem with power supply, or the like, the photosensor 66 outputs the signal A to the controller 90. Upon receiving this signal, the controller 90 outputs a signal to the controller 100 indicating the closed state of the second valve 60. Upon receiving this signal, the controller 100 controls the inkjet heads 2 to halt ink ejection, and controls the feeding roller 25, conveying rollers 26, conveying unit 21, and conveying rollers 28 to discharge the sheet P currently being printed onto the paper discharging unit 31. Thus, the controller 100 halts ink ejection from the inkjet heads 2 when the second valves 60 are placed in the closed state for any reason. This can prevent a large negative pressure from being produced in the ink channels leading from the second valves 60 to the inkjet heads 2 caused by continuing to eject ink from the inkjet heads 2. Avoiding the generation of negative pressure prevents breakage of the meniscuses formed near the ejection openings in the inkjet heads 2 and prevents air from entering these openings.

With the inkjet printer 1 according to this embodiment described above, the second valve 60 of the ink cartridge 40 is shifted to the open state the prescribed time (first and second prescribed times) after the ink cartridge 40 is mounted in the corresponding mounting unit 150. Hence, a time difference equivalent to the prescribed time is produced after the ink cartridge 40 is mounted in the mounting unit 150 and until the ink channel connecting the ink bag 42 of the ink cartridge 40 to the inkjet head 2 is formed. Thus, even though a change in ink pressure is generated in the ink bag 42 by movement of the ink cartridge 40 when the ink cartridge 40 is mounted in the mounting unit 150, ink in the ink cartridge 40 is only supplied to the inkjet head 2 after this change in pressure subsides. Therefore, the inkjet printer 1 of this embodiment can prevent breakage of ink meniscuses formed in the ejection openings of the inkjet heads 2.

The storage unit 125 stores data indicating prescribed times that are longer when the initial quantity of ink in the ink cartridge 40 is greater. Therefore, the present embodiment ensures that ink in the ink cartridge 40 is not supplied to the inkjet head 2 until changes in ink pressure have subsided, even when mounting an ink cartridge containing a large quantity of ink (a cartridge storing black ink). Hence, the inkjet printer 1 according to this embodiment can better suppress breakage of ink meniscuses formed in the ejection openings of the inkjet heads 2.

Providing the actuator 70 in the ink cartridge 40 improves the precision of positioning the actuator 70 relative to the second valve 60. Hence, the second valve 60 can be opened and closed with greater precision.

Further, the second valve 60 is placed in the closed state when the ink cartridge 40 is removed from the body of the inkjet printer 1. Since the second valve 60 blocks communication in the ink channel 43a, the second valve 60 can suppress the quantity of ink leakage if the first valve 50 becomes damaged when shifted to the closed state.

As a first variation of the first embodiment, the photosensor 170 may output a signal directly to the controller 90 indicating whether the ink cartridge 40 is mounted in the mounting unit 150 (whether the first valve 50 is in the open state or the closed state). Upon receiving a signal indicating that the ink cartridge 40 has been mounted in the mounting unit 150 (the first valve 50 is in the open state), the controller 90 may operate the actuator 70 to shift the second valve 60 to the open state after a prescribed time corresponding to the ink volume (the first or second prescribed time) has elapsed. When receiving a signal indicating that the ink cartridge 40 is not mounted in the mounting unit 150 (that the first valve 50 is in the closed state), the controller 90 may operate the actuator 70 to shift the second valve 60 to the closed state.

As a second variation of the first embodiment, the controller 100 may be configured to execute at least some of the processes and determinations executed by the controller 90 in S3, S5, S6, S7, and S8 when the ink cartridge 40 is mounted in the body of the inkjet printer 1.

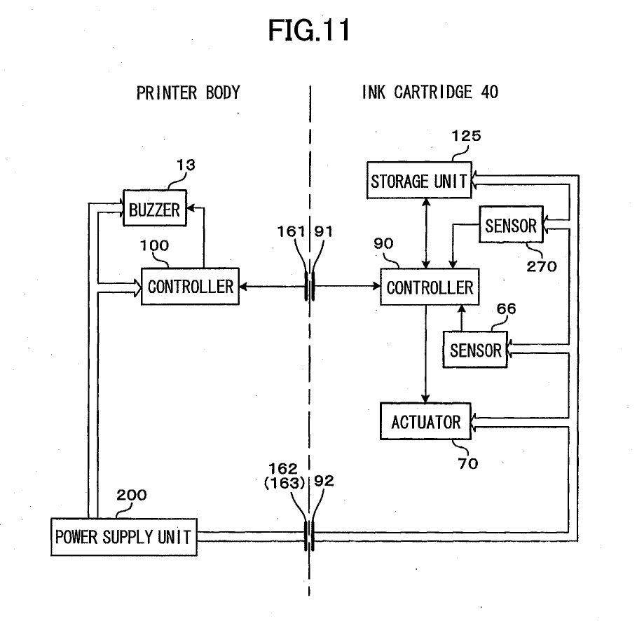

As a third variation of the first embodiment, a sensor 270 (cartridge side detecting unit) may be provided in the ink cartridge in place of the photosensor 170 provided in the body of the printer for producing a signal indicating whether the ink cartridge 40 is mounted in the mounting unit 150 (whether the first valve 50 is in the open state or the closed state). FIG. 11 is a block diagram showing the electrical configuration of the inkjet printer 1 and ink cartridge 40 according to this variation. As shown in FIG. 11, the sensor 270 outputs a signal to the controller 90, and the controller 90 transfers this signal to the controller 100. The sensor 270 may be a reflective-type photosensor, for example, and is configured to generate different signals for when the ink cartridge 40 is mounted and not mounted in the mounting unit 150.

As a fourth variation of the first embodiment, when the ink cartridge 40 is mounted in the mounting unit 150, the contact point 91 and contact point 161 and the power input unit 92 and contact point 163 may be electrically connected within a prescribed time stored in the storage unit 125 after the first valve 50 has shifted to the open state. Further, the power input unit 92 and contact point 163 are preferably connected after electrically connecting the contact point 91 and contact point 161. In this variation, the contact point 91 and contact point 161 and the power input unit 92 and contact point 163 are connected when the ink cartridge 40 is mounted in the mounting unit 150 according to the same operations described in the first embodiment, but only after the first valve 50 has shifted to the open state.

Conversely, when the ink cartridge 40 is removed from the mounting unit 150, first the supply of power to the controller 90, actuator 70, and sensor 66 of the ink cartridge 40 is cut off, thereby automatically shifting the second valve 60 to the closed state. Next, the first valve 50 is shifted to the closed state due to the extraction of the hollow needle 153. At this time, the photosensor 170 may output a signal to the controller 100 indicating the closed states of the first valve 50 and second valve 60. As in the first embodiment described above, the controller 100 may stop ink ejection from the inkjet heads 2 upon receiving a signal from the controller 90 indicating that the second valve 60 is in the closed state, even when the second valve 60 is shifted to the closed state during printing due to some factor.

As a fifth variation of the first embodiment, the first valve may be configured of only a sealing member that has no slit formed therein. In this case, the first valve is considered to be in the open state when the hole 153b formed in the hollow needle 153 passes through the sealing member at a timing in which the photosensor 170 detects the protrusion 41d. In this way, the first valve can be formed of a simpler construction comprising only a sealing member.

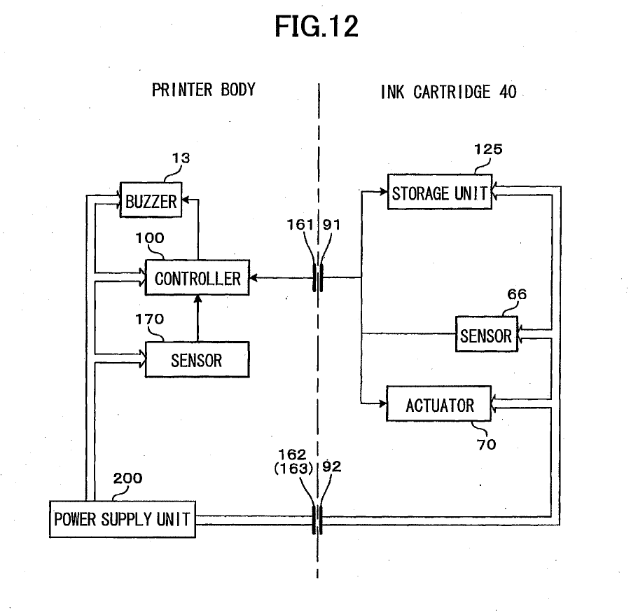

Next, a second embodiment of the present invention will be described with reference to FIG. 12. FIG. 12 is a block diagram showing the electrical configuration of the inkjet printer 1 and ink cartridge 40 according to the second embodiment. Unlike the first embodiment described above, the ink cartridge 40 according to the second embodiment is not provided with the controller 90 and a direct signal transmission path is established between the storage unit 125 and photosensor 66 and the controller 100 when the contact point 91 and contact point 161 are electrically connected. The remaining structure is identical to that described in the first embodiment.

In the second embodiment, the controller 100 executes all processes and determinations shown in FIG. 10 that were performed by the controller 90 in the first embodiment. Hence, in S2 the controller 100 reads data from the storage unit 125. In S3 the controller 100 determines whether data was properly read from the storage unit 125. In S5 the controller 100 determines whether the prescribed time has elapsed since mounting of the ink cartridge 40 was detected. In S6 the controller 100 outputs a signal to the actuator 70 for operating the actuator 70. In S7 the controller 100 determines whether the operation of the actuator 70 is completed. In S8 the controller 100 determines whether the second valve 60 has shifted from the closed state to the open state. In S12, the controller 100 waits till the default time has elapsed after mounting was detected.

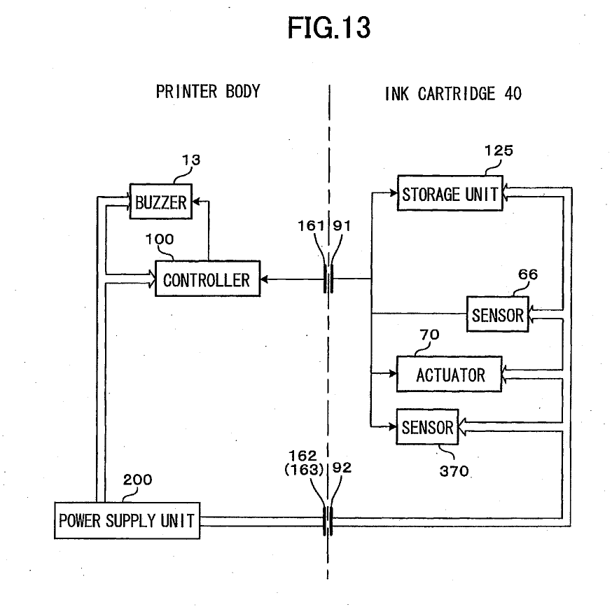

As a first variation of the second embodiment, a sensor 370 (cartridge side detecting unit) may be provided in the ink cartridge 40 in place of the photosensor 170 provided in the body of the inkjet printer 1. The sensor 370 generates a signal indicating whether the ink cartridge 40 is mounted in the mounting unit 150 (whether the first valve 50 is in the open state or the closed state). FIG. 13 is a block diagram illustrating the electrical configuration of the inkjet printer 1 and ink cartridge 40 according to this variation of the second embodiment. As shown in FIG. 13, a direct signal transmission path is established between the sensor 370 and the controller 100 when the contact point 91 and contact point 161 are electrically connected, enabling the sensor 370 to output signals to the controller 100. The sensor 370 may be configured of a reflective-type optical sensor, for example, and produces different signals indicating whether the ink cartridge 40 is mounted and not mounted in the mounting unit 150.

While the invention has been described in detail with reference to specific embodiments thereof, it would be apparent to those skilled in the art that many modifications and variations may be made therein without departing from the spirit of the invention, the scope of which is defined by the attached claims.

For example, the inkjet printer 1 according to the above embodiments described above uses the photosensor 170 and the protrusion 41d both to detect when the ink cartridge 40 is completely mounted in the mounting unit 150 and to detect the open state of the first valve 50 by configuring the first valve 50 to shift from the closed state to the open state at the same time mounting is completed. However, there may be cases in which the first valve 50 does not change from the closed state to the open state at the same time the ink cartridge 40 is completely mounted in the mounting unit 150. In such cases, a photosensor or magnetic sensor may be provided in addition to the photosensor 170 and protrusion 41d for detecting the position of the spherical member 52 constituting the first valve 50 in order to determine the open and closed state of the first valve 50. Further, the photosensor 170 may be configured to detect a corner of the case 41 instead of the protrusion 41d.

Further, the sensor 66 and protrusion 62b in the above embodiments described above may be omitted. In other words, the inkjet printer 1 need not be provided with means for detecting the open and closed state of the second valve 60.

Further, the first valve may have a configuration other than that described in the above embodiments, provided that the first valve is disposed in the ink delivery tube and can be selectively switched between an open state for allowing communication in the ink delivery tube and a closed state for blocking communication in the ink delivery tube. For example, the first valve may be configured of an electrically-operated valve that can be controlled to open and close. The valve is normally in the closed state and the controller 90 or controller 100 controls the valve to open only when the ink cartridge 40 is mounted in the body of the inkjet printer 1.

Similarly, the second valve may have a structure different from that described in the above embodiments, provided that the second valve is disposed in the ink delivery tube between the ink bag and the first valve and can be selectively switched between an open state for allowing communication in the ink channel in the ink delivery tube leading from the ink bag to the first valve, and a closed state for blocking this channel.

Further, a display may be provided on the casing 1a in place of the buzzer 13 for displaying images representing error message in place of the sounds emitted by the buzzer 13 in order to notify the user. Alternatively, both the buzzer and display may be used in combination.

In the embodiments described above, the power supply unit provided in the body of the inkjet printer 1 is configured to supply electrical power to the ink cartridge 40 when the ink cartridge 40 is mounted in the mounting unit 150, but the ink cartridges 40 may be configured to be self-powered. Further, the ink cartridges 40 are not limited to cartridges that supply ink, but may be cartridges that supply a liquid other than ink that require maintenance.

What is claimed is:

1. A liquid cartridge detachably mountable on a body of an image forming device and capable of supplying liquid to the image forming device when mounted on the body, the liquid cartridge comprising:
a liquid accommodating unit that is configured to accommodate liquid therein;
a liquid delivery path that is in fluid communication with the liquid accommodating unit and supplies liquid externally from the liquid accommodating unit, the liquid delivery path having a first portion and a second portion positioned between the liquid accommodating unit and the first portion;
a first opening/closing unit that is configured so as to be capable of being switched between an open state in which the first portion is opened and a closed state in which the first portion is closed;
a second opening/closing unit that is configured so as to be capable of being switched between an open state in which the second portion is opened and a closed state in which the second portion is closed; and
a storing unit that is configured to store time length data indicating a length of a prescribed time, the second opening/closing unit being changed from the closed state to the open state when the prescribed time has elapsed after the liquid cartridge is mounted on the body.

2. The liquid cartridge as claimed in claim 1, further comprising a drive unit that drives the second opening/closing unit so as to be changed from the closed state to the open state when the prescribed time has elapsed after the liquid cartridge is mounted on the body.

3. The liquid cartridge as claimed in claim 1, wherein the length of the prescribed time represents a recommended value of a time period between a first time point and a second time point, the first time point indicating a time point at which the liquid cartridge is mounted on the body, the second time point indicating a time point at which the second opening/closing unit is changed from the closed state to the open state.

4. The liquid cartridge as claimed in claim 1, further comprising a cartridge controller that reads the time length data from the storing unit and controls the second opening/closing unit to switch from the closed state to the open state when the prescribed time has elapsed after the liquid cartridge is mounted on the body.

5. The liquid cartridge as claimed in claim 1, further comprising:
a cartridge side detecting unit that detects whether or not the liquid cartridge is mounted on the body; and
a cartridge controller that reads the time length data from the storing unit and controls the second opening/closing unit to switch from the closed state to the open state when the prescribed time has elapsed after the cartridge side detecting unit detects that the liquid cartridge is mounted on the body.

6. An image forming device comprising:
a body; and
the liquid cartridge as claimed in claim 1 that is detachably mounted on the body for supplying liquid to the body,
wherein the body comprises:
a liquid ejecting head that ejects the liquid supplied from the liquid cartridge;
a body controller that controls the liquid ejecting head;
a body side detecting unit that detects whether or not the liquid cartridge is mounted on the body; and
a first contact point,
wherein the liquid cartridge further comprises:
a cartridge controller; and
a second contact point that is configured to contact the first contact point to establish a signal transmission path between the body controller and the cartridge controller when the liquid cartridge is mounted on the body;
wherein the cartridge controller reads the time length data from the storing unit and controls the second opening/closing unit to switch from the closed state to the open state when the prescribed time has elapsed after the body side detecting unit detects that the liquid cartridge is mounted on the body.

7. The image forming device as claimed in claim 6, wherein the liquid cartridge further includes an opening/closing detecting unit that detects whether the second opening/closing unit is in the open state or the closed state,
wherein the body controller controls the liquid ejection head to halt liquid ejection therefrom when the opening/closing detecting unit detects that the second opening/closing unit is in the closed state.

8. An image forming device comprising:
a body; and
the liquid cartridge as claimed in claim 1 that is detachably mounted on the body for supplying liquid to the body,
wherein the body comprises:
a liquid ejecting head that ejects the liquid supplied from the liquid cartridge;
a body controller that controls the liquid ejecting head; and
a first contact point,
wherein the liquid cartridge further comprises:
a cartridge side detecting unit that detects whether or not the liquid cartridge is mounted on the body;
a cartridge controller; and
a second contact point that is configured to contact the first contact point to establish a signal transmission path between the body controller and the cartridge controller when the liquid cartridge is mounted on the body,
wherein the cartridge controller reads the time length data from the storing unit and controls the second opening/closing unit to switch from the closed state to the open state when the prescribed time has elapsed after the cartridge side detecting unit detects that the liquid cartridge is mounted on the body.

9. The image forming device as claimed in claim 8, wherein the liquid cartridge further includes an opening/closing detecting unit that detects whether the second opening/closing unit is in the open state or the closed state,
wherein the body controller controls the liquid ejection head to halt liquid ejection therefrom when the opening/closing detecting unit detects that the second opening/closing unit is in the closed state.

10. An image forming device comprising:
a body; and
the liquid cartridge as claimed in claim 1 that is detachably mounted on the body for supplying liquid to the body,
wherein the body comprises:
a liquid ejecting head that ejects the liquid supplied from the liquid cartridge;
a body controller that controls the liquid ejecting head;
a body side detecting unit that detects whether or not the liquid cartridge is mounted on the body; and
a first contact point,
wherein the liquid cartridge further comprises:
a second contact point that is configured to contact the first contact point to establish a signal transmission path between the body controller and the storage unit when the liquid cartridge is mounted on the body,
wherein the body controller reads the time length data from the storing unit when the liquid cartridge is mounted on the body and controls the second opening/closing unit to switch from the closed state to the open state when the prescribed time has elapsed after the body side detecting unit detects that the liquid cartridge is mounted on the body.

11. The image forming device as claimed in claim 10, wherein the liquid cartridge further includes an opening/closing detecting unit that detects whether the second opening/closing unit is in the open state or the closed state,
wherein the body controller controls the liquid ejection head to halt liquid ejection therefrom when the opening/closing detecting unit detects that the second opening/closing unit is in the closed state.

12. An image forming device comprising:
a body; and
the liquid cartridge as claimed in claim 1 that is detachably mounted on the body for supplying liquid to the body,
wherein the body comprises:
a liquid ejecting head that ejects the liquid supplied from the liquid cartridge;
a body controller that controls the liquid ejecting head; and
a first contact point,
wherein the liquid cartridge further comprises:
a cartridge side detecting unit that detects whether or not the liquid cartridge is mounted on the body; and
a second contact point that is configured to contact the first contact point to establish a signal transmission path between the body controller, and the storage unit and the cartridge side detecting unit when the liquid cartridge is mounted on the body,
wherein the body controller reads the time length data from the storing unit when the liquid cartridge is mounted on the body and controls the second opening/closing unit to switch from the closed state to the open state when the prescribed time has elapsed after the cartridge side detecting unit detects that the liquid cartridge is mounted on the body.

13. The image forming device as claimed in claim 12, wherein the liquid cartridge further includes an opening/closing detecting unit that detects whether the second opening/closing unit is in the open state or the closed state,
wherein the body controller controls the liquid ejection head to halt liquid ejection therefrom when the opening/closing detecting unit detects that the second opening/closing unit is in the closed state.

14. A liquid cartridge comprising:
a liquid accommodating unit that is configured to accommodate liquid therein;
a liquid delivery path that is in fluid communication with the liquid accommodating unit and supplies liquid externally from the liquid accommodating unit, the liquid delivery path having a first portion and a second portion positioned between the liquid accommodating unit and the first portion;
a first opening/closing unit that is configured so as to be capable of being switched between an open state in which the first portion is opened and a closed state in which the first portion is closed;
a second opening/closing unit that is configured so as to be capable of being switched between an open state in which the second portion is opened and a closed state in which the second portion is closed;
a storing unit that is configured to store time length data indicating a length of a prescribed time, the length of the prescribed time representing a recommended value of a time period between a first time point and a second time point, the first time point indicating a time point at which the first opening/closing unit is switched from the closed state to the open state, the second time point indicating a time point at which the second opening/closing unit is switched from the closed state to the open state; and
a cartridge controller that controls the second opening/closing unit to switch from the closed state to the open state when the prescribed time has elapsed after the first opening/closing unit is switched from the closed state to the open state.
